(19) United States
(12) Patent Application Publication
(10) Pub. No.: US 2023/0257246 A1
(43) Pub. Date: Aug. 17, 2023

(54) BEVERAGE DISPENSER AND METHOD OF DISPENSING A BEVERAGE

(71) Applicant: PepsiCo, Inc., Purchase, NY (US)

(72) Inventors: Giancarlo FANTAPPIE, Rancho Palos Verdes, CA (US); Diego MACRELLINO, Torrance, CA (US); Steven JERSEY, Laguna Niguel, CA (US)

(21) Appl. No.: 18/169,709

(22) Filed: Feb. 15, 2023

Related U.S. Application Data
(60) Provisional application No. 63/310,874, filed on Feb. 16, 2022.

(51) Int. Cl. B67D 1/00; B67D 1/08

(52) U.S. Cl. CPC B67D 1/0017; B67D 1/0061; B67D 1/0857; B67D 1/0895; B67D 2210/00039; B67D 2210/00086; B67D 2210/00118

(57) ABSTRACT

A beverage dispenser inclues a housing and a base liquid nozzle arranged on the housing and configured to dispense a base liquid. The beverage dispenser further includes an additive nozzle arranged on the housing and configured to dispense an additive. The beverage dispenser includes a user interface arranged on the housing, and the user interface is configured to receive a first selection of a base liquid and at least one of a temperature of the base liquid and a carbonation level of the base liquid, and a second selection of an additive. The beverage dispenser is configured to dispense the base liquid from the base liquid nozzle based on the first selection, and wherein the additive nozzle is configured to dispense the additive based on the second selection.

### FIELD

Embodiments described herein generally relate to a beverage dispenser for dispensing a custom beverage. Specifically, embodiments described herein relate to a beverage dispenser for dispensing a custom beverage including a base liquid with a selectable temperature, carbonation level, volume, and optionally an additive.

### BACKGROUND

Beverage dispensers are used to dispense a beverage into a container in an on-demand fashion. Beverage dispensers, such as fountain beverage dispensers, are commonly used in commercial settings, such as in restaurants, bars, theaters, sporting venues, and convenience stores, among others. Such beverage dispensers may dispense a beverage from a storage reservoir or may combine a flavoring with a base liquid at the point of dispense. A user may operate the beverage dispenser by placing a cup below a beverage dispensing nozzle, selecting a desired beverage using an interface of the beverage dispenser, and selecting to dispense the beverage, such as by pressing a button or by operating a lever for a period of time and visually determining when the desired amount of beverage has been dispensed.

### SUMMARY OF THE INVENTION

Some embodiments described herein relate to a beverage dispenser that includes a housing, a base liquid nozzle arranged on the housing and configured to dispense a base liquid, and an additive nozzle arranged on the housing and configured to dispense an additive. The beverage dispenser further includes a user interface arranged on the housing, wherein the user interface is configured to receive a first selection of a base liquid and a temperature or carbonation level of the base liquid, and a second selection of an additive, wherein the beverage dispenser is configured to prepare and dispense the base liquid from the base liquid nozzle based on the first selection, and wherein the additive nozzle is configured to dispense the additive based on the second selection.

In any of the various embodiments described herein, the beverage dispenser may be further configured to receive a selection of a volume of the base liquid to be dispensed.

In any of the various embodiments described herein, the user interface may include a touch screen display configured to display a plurality of selectable options. In some embodiments, the beverage dispenser may further include a biometric sensor configured to determine an identity of the user, wherein the plurality of selectable options are based on the identity of the user.

In any of the various embodiments described herein, the beverage dispenser may further include a carbonator configured to carbonate the base liquid, and the beverage dispenser may provide a dose of carbon dioxide to the carbonator based on the selected carbonation level.

In any of the various embodiments described herein, the beverage dispenser may include a heat exchanger configured to cool the base liquid.

In any of the various embodiments described herein, the beverage dispenser may include a heating device configured to heat the base liquid.

In any of the various embodiments described herein, the housing may define a storage compartment for removably receiving a consumable for operating the beverage dispenser, and the consumable is selected from a carbon dioxide tank, a filter cartridge, and an additive container. In some embodiments, the beverage dispenser may further include an indicator configured to indicate an amount of the consumable remaining in the beverage dispenser.

In any of the various embodiments described herein, the housing of the beverage dispenser may include one or more removable panels.

Some embodiments described herein relate to a a beverage dispenser that includes a housing, a base liquid nozzle configured to dispense a base liquid, and a user interface configured to receive a selection including a base liquid and at least one of a temperature of the base liquid and a carbonation level of the base liquid. The beverage dispenser furhter includes an additive dispenser that includes an additive nozzle arranged on the housing, a Atty. Dkt. No. 4711.2010002 holder configured to removably receive an additive container, and a dispensing mechanism configured to dispense a dose of additive from the additive container via the additive nozzle.

In any of the various embodiments described herein, the user interface may be configured to receive a selection of a volume of the beverage to be dispensed. In some embodiments, the additive dispenser may be configured to dispense a quantity of the additive based on the selected volume of the base liquid.

In any of the various embodiments described herein, the user interface may be configured to display selectable options based on the identity of the user.

Some embodiments described herein relate to a method of dispensing a beverage from a beverage dispenser, the method including receiving, by the beverage dispenser, a selection of a temperature or a carbonation level of a base liquid, receiving by the beverage dispenser a volume of the base liquid to be dispensed, and receiving by the beverage dispenser a command to dispense the selected base liquid. The method further includes at least one of chilling or heating the base liquid by the beverage dispenser to the selected temperature and providing a dose of carbon dioxide into a carbonator of the beverage dispenser, wherein the dose is based on the selected carbonation level, and dispensing the selected volume of the base liquid at the selected temperature or carbonation level.

In any of the various embodiments described herein, the method may further include receiving, by the beverage dispenser, a selection of an additive. In some embodiments, the method further includes dispensing a dose of the selected additive based on the selected volume of the base liquid.

In any of the various embodiments described herein, receiving a selection of a base liquid further includes receiving the selection from a mobile electronic device.

In any of the various embodiments described herein, the method further includes displaying selectable options for the base liquid on a user interface of the beverage dispenser. In some embodiments, the method includes detecting an identity of a user, and the selectable options displayed on the user interface are based on the identity of the user.

### BRIEF DESCRIPTION OF THE DRAWINGS/FIGURES

The accompanying drawings, which are incorporated herein and form a part of the specification, illustrate the present disclosure and, together with the description, further serve to explain the principles thereof and to enable a person skilled in the pertinent art to make and use the same.

FIG. 1 shows a perspective view of a beverage dispenser according to an embodiment.

FIG. 2 shows a front view of the beverage dispenser of FIG. 1 having removable panels.

FIG. 3 shows a perspective view of the beverage dispenser of FIG. 1 with a door in an open position to show a storage compartment of the beverage dispenser.

FIG. 4 shows a schematic diagram of components of a beverage dispenser according to an embodiment.

FIG. 5 shows a user interface of a beverage dispenser according to an embodiment.

FIG. 6 shows a user interface of a beverage dispenser according to an embodiment.

FIG. 7 shows a schematic diagram of components of a beverage dispenser according to an embodiment.

FIG. 8 shows a portion of an additive dispensing mechanism according to an embodiment.

FIG. 9 shows an exemplary method of dispensing a beverage from a beverage dispenser.

FIG. 10 shows a perspective view of a stand-alone additive dispenser according to an embodiment.

FIG. 11 shows a view of an additive dispensing mechanism of the additive dispenser of FIG. 10 in an embodiment.

FIG. 12 shows a perspective view of the additive dispenser of FIG. 10 having a user interface.

FIG. 13 shows a schematic diagram of components of the additive dispenser according to an embodiment.

FIG. 14 shows a schematic block diagram of an exemplary computer system in which embodiments may be implemented.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the claims.

Beverage dispensers are used to dispense a beverage in an on-demand basis. However, many beverage dispensers do not allow for customization of the beverage being dispensed, and simply allow the user to select a type of beverage to dispense. Consumers increasingly desire the ability to customize a beverage to suit their tastes and preferences. In addition to selecting the type of beverage, a consumer may wish to select a temperature for the beverage, a carbonation level, and an amount of flavoring. However, beverage dispensers generally do not provide consumers with such flexibility to customize a beverage.

Further, beverage dispensers may rely on bulky carbonation tanks, complex water filtration systems, and bag-in-boxes (BiB) for storing flavorings. Such beverage dispensers may be large and bulky and as a result are not suitable for use in a home or office setting. Further, consumers may have difficulty operating and maintaining such beverage dispensers, and may have difficulty determining when and whether to replace components of the beverage dispenser. When replacement of components is needed, such components may not be readily available for purchase. If the components need to be replaced, the consumer may lack the tools and experience to replace the components and may require assistance from a qualified technician in order to remove and replace used components. The need for a technician to assist in replacement of components may result in a lengthy period in which the beverage dispenser cannot be used until it is serviced, and the repairs may be costly.

Additionally, beverage dispensers often dispense base liquids and additives from the same dispensing nozzle. However, additives with high dilution factors (e.g., 100:1 or more) often contain volatile aromatic compounds whose odor may persist in dispensing lines even after dispensing is complete. If the beverage dispenser uses a nozzle to dispense a base liquid and also the high-dilution factor additives, there may be cross-contamination of flavors which is undesirable. Thus, it would be desirable to store additives in containers within the dispenser that are dispensed by a nozzle that is separate from the nozzle used to dispense the base liquid to reduce or eliminate cross-contamination of additive flavors.

Thus, there is a need for a beverage dispenser for dispensing custom beverages that is compact and is suitable for use in home or office settings, and that facilitates operation and maintenance by the user.

Some embodiments described herein relate to a beverage dispenser that includes a user interface for selecting a custom beverage including a base liquid at a desired temperature, carbonation level, or both, a volume of the selected beverage, and optionally an additive. In this way, the user may select and dispense a custom beverage each time a beverage is dispensed. Some embodiments relate to a beverage dispenser with replaceable consumables including a carbon dioxide tank, filter cartridge, and additive containers. In this way, the beverage dispenser facilitates operation and maintenance by the user without assistance from a skilled technician to replace components of the system. Some embodiments described herein relate to a beverage dispenser that includes an additive dispenser configured to determine and dispense a dose of an additive to achieve the appropriate dilution of the additive in the base liquid. In this way, the user need not manually add an additive and guess at the appropriate amount of additive to use by trial and error.

As used herein, the term “base liquid” may refer to a consumable liquid to which one or more additives may be added. For example, the base liquid may be still water, among others.

As used herein, the term “additive” may refer to a beverage ingredient, such as in a liquid form or solid form, e.g., granular or powdered form. The additive may include a syrup, concentrate, flavoring, enhancer, sweetener, or nutrient, among others.

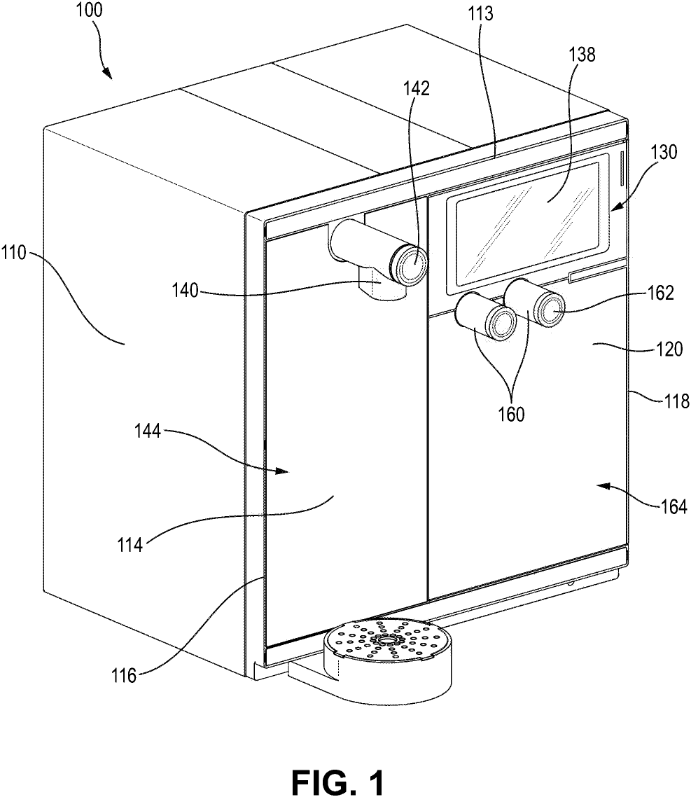

Some embodiments relate to a beverage dispenser 100 for dispensing custom beverages, as shown for example in FIG. 1. Beverage dispenser 100 may have a compact configuration and may be configured to be positioned on a countertop, such as on a kitchen counter. Beverage dispenser 100 may include a housing 110 that encloses components of beverage dispenser 100. Beverage dispenser 100 may include a door 120 for providing access to a storage compartment, as described in further detail below. Beverage dispenser 100 may include a user interface 130 configured to receive user input for selection of a custom beverage. Beverage dispenser 100 may include one or more nozzles 140, 160 for dispensing a base liquid and an additive. Nozzles 140, 160 may extend from housing 110, such as from a front wall 114 of housing 110.

In some embodiments, base liquid nozzle 140 is used to dispense the selected base liquid, and a separate additive nozzle 160 is used to dispense an additive. Base liquid nozzle 140 and additive nozzles 160 may be separate and independent of one another. Further, base liquid nozzle 140 and additive nozzle 160 may be spaced from one another, and may be arranged on separate portions of housing 110. In some embodiments, beverage dispenser 100 may include multiple base liquid nozzles 140, multiple additive nozzles 160, or multiple base liquid and additive nozzles 140, 160. For example, as shown in FIG. 1, beverage dispenser 100 includes one base liquid nozzle 140 and two additive nozzles 160. In such embodiments, each additive nozzle 160 may be configured to dispense a different additive. For example, a first additive nozzle 160 may dispense a lime flavoring, while a second additive nozzle 160 may dispense a grape flavoring. However, in some embodiments, each additive nozzle 160 may dispense the same additive.

In some embodiments, base liquid nozzle 140 may be arranged on a front wall 114 of housing 110 at an upper end 113 of housing 110 and toward a first side 116 of housing 110. Base liquid nozzle 140 may extend outwardly from front wall 114 of housing 110 and may define a container receiving area 144 below base liquid nozzle 140, such that a consumer may place a beverage container in container receiving area 144 to fill beverage container via base liquid nozzle 140. Additive nozzles 160 may be arranged on front wall 114 of housing 110 and may extend outwardly from housing 110 to define a second container receiving area 164 below additive nozzles 160. In some embodiments, additive nozzles 160 may be arranged on front wall 114 below user interface 130 and toward a second side 118 of housing 110.

In operation, a base liquid may be dispensed from a base liquid nozzle 140 into a beverage container, and an additive may be dispensed from an additive nozzle 160 into the beverage container, such that the base liquid and additive mix within the beverage container. Alternatively, an additive may be dispensed into the beverage container, and then the base liquid may be dispensed into the container, such that the base liquid mixes with the additive already in the container as the base liquid is being dispensed.

User interface 130 of beverage dispenser 100 may be arranged on a front wall 114 of housing 110 so as to be easily accessed by the user. In some embodiments, user interface 130 may include a display 138 for displaying selectable beverage options among other information as discussed herein. Display 138 may include a liquid crystal display (LCD), light emitting diode (LED) display, quantum dot display (QLED), organic LED (OLED) display, plasma display panel, alphanumeric display, or e-ink display, among others. User interface 130 may include one or more input devices, such as buttons, dials, knobs, levers, switches, or the like for receiving a user input. In some embodiments, user interface 130 may include a touch-screen display that serves as the input device for receiving a touch inputs. User interface 130 may allow for selection of a base liquid, a temperature of the base liquid, a level of carbonation of the base liquid, a volume of the base liquid, and may further be used for selection of an additive, as discussed in further detail herein. Beverage dispenser 100 may also include one or more input devices 142, 162 on each nozzle 140, 160, such as a push button, a touch button (capacitive sensor), or a proximity sensor, for dispensing a base liquid or additive from the respective nozzle 140, 160.

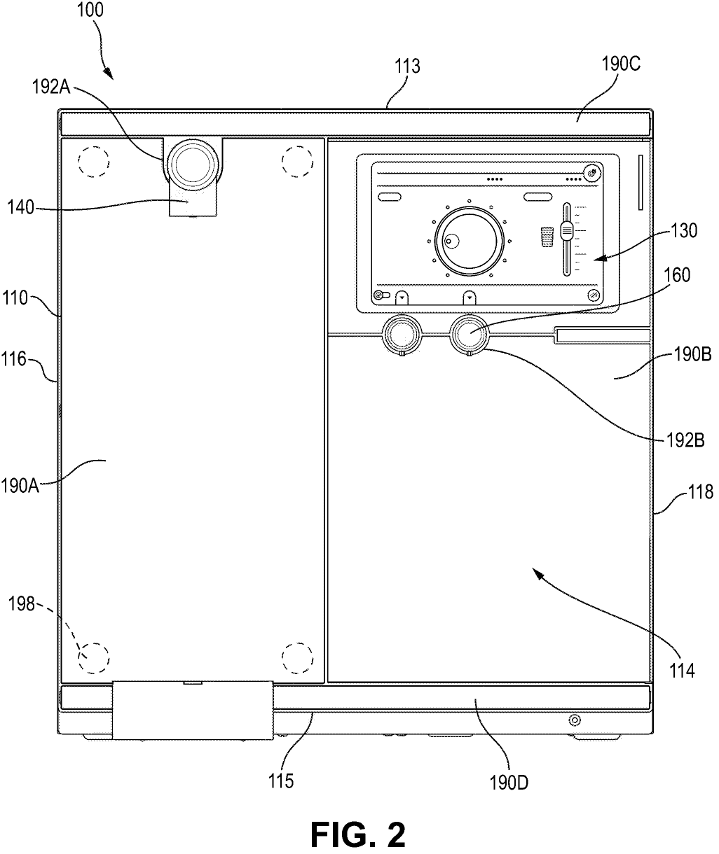

In some embodiments, beverage dispenser 100 may include one or more panels 190 removably securable to housing 110, as shown for example in FIG. 2. Removable panels 190 may include any of various colors, patterns, textures, designs, and images thereon. Removable panels 190 may be selected to suit the decor or style of the room in which beverage dispenser 100 is installed, and may be selected to suit the owner’s style and taste. For example, panels 190 may include solid colors configured to match a color scheme of a room in which beverage dispenser 100 is stationed. Panels 190 may resemble wood, and may have a wood grain. Panels 190 may include a metallic appearance, such as a brushed or polished metal. Panels 190 may include an image, such as a photographic image. In embodiments with multiple removable panels 190, one photographic image may cover multiple removable panels 190 such that the assembled panels 190 depict the full image.

In FIG. 2, beverage dispenser 100 is shown as having four panels 190A, 190B, 190C, 190D removably secured to front wall 114 of housing 110. However, it is understood that additional or fewer panels 190 may be present in other embodiments. Housing 110 may include fasteners 198 for removably securing panels 190 to housing 110. In some embodiments, fasteners 198 may be arranged at a corner of each panel 190. In some embodiments, fasteners 198 may be magnetic, or fasteners 198 of each panel 190 may engage with fasteners of housing 110 by a mating connection, and may be snap-fit, friction-fit, press-fit, or the like.

In some embodiments as shown for example in FIG. 2, a first panel 190A is arranged on a first side 116 of housing 110 and may extend between upper end 113 and lower end 115 of housing 110. First panel 190A may include a cutout 192A to accommodate base liquid nozzle 140. A second panel 190B may be arranged on an opposing second side 118 of housing 110, such as in an area below user interface 130. Second panel 190B may be arranged on a door of housing 110. Second panel 190B may include cutouts 192B to accommodate additive nozzle(s) 160. A third panel 190C may be arranged along an upper end 113 of housing 110 and extends from first side 116 to second side 118 of housing 110. A fourth panel 190D may be arranged along a lower end 115 of housing 110 and extends from first side 116 to second side 118 of housing 110.

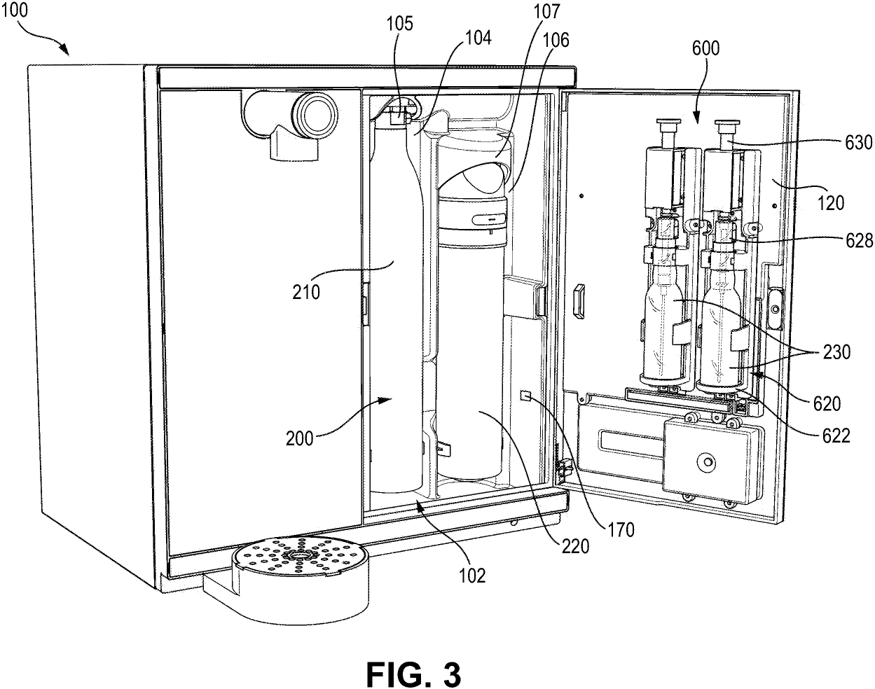

Beverage dispenser 100 may include a storage compartment 102 for storing consumable components (“consumables”) 200, as shown for example in FIG. 3. Consumables 200 may include, for example, carbon dioxide tanks 210, filter cartridges 220, and additive containers 230. Storage compartment 102 may be defined by housing 110 and may be removably covered by a door 120 of housing 110. Door 120 may be movably connected to housing 110, and may be movable from a closed position in which storage compartment 102 is not accessible by a user to an open position in which storage compartment 102 and consumables 200 therein are accessible to the user. Door 120 may be movably connected to housing 110 via a hinge. However, in some embodiments, door 120 may be slidably connected to housing 110, such as via a track, or door 120 may be fully removable from housing 110. In FIG. 3, door 120 is shown as forming a portion of front wall 114 of housing 110. However, in alternate embodiments, door 120 may be arranged in other locations on housing 110, such as on a lateral sidewall or rear wall of beverage dispenser 100. In some embodiments, door 120 may include user interface 130 and an additive dispenser 600 arranged thereon.

Consumables 200 used by beverage dispenser 100 may be off-the-shelf components that can be easily removed from and installed in beverage dispenser 100 by the user without assistance from a skilled technician. In some embodiments, consumables 200 may be removed and installed without the use of tools. In this way, the consumer may easily operate and maintain beverage dispenser 100. Storage compartment 102 may be configured to receive a carbon dioxide tank 210 for use in supplying carbon dioxide to a carbonator of beverage dispenser 100. Storage compartment 102 may include a first area 104 for receiving a carbon dioxide tank 210, and may include a connection 105 for removable connection to carbon dioxide tank 210 to place the carbon dioxide in fluid communication with a carbonator of beverage dispenser 100. Connection 105 may include threading for receiving threading of carbon dioxide tank 210, such that carbon dioxide tank 210 can be removed and installed without tools. Storage compartment 102 may include a second area 106 for receiving a filter cartridge 220. Storage compartment 102 may include a connection 107 for removably placing filter cartridge 220 in fluid communication with a base liquid supply line to filter the base liquid, e.g., water, supplied to and dispensed by beverage dispenser 100. In this way, carbon dioxide tank 210 and filter cartridge 220 can be easily removed and replaced by the user.

In some embodiments, storage compartment 102 may receive and store one or more additive containers 230. In some embodiments, a door 120 of beverage dispenser 100 may include an additive dispenser 600 with a holder for receiving additive container 230. Door 120 may include connections 628 for placing additive containers 230 in fluid communication with additive nozzles 160. In some embodiments, storage compartment 102 may include additional storage areas for storing extra consumables, among other components.

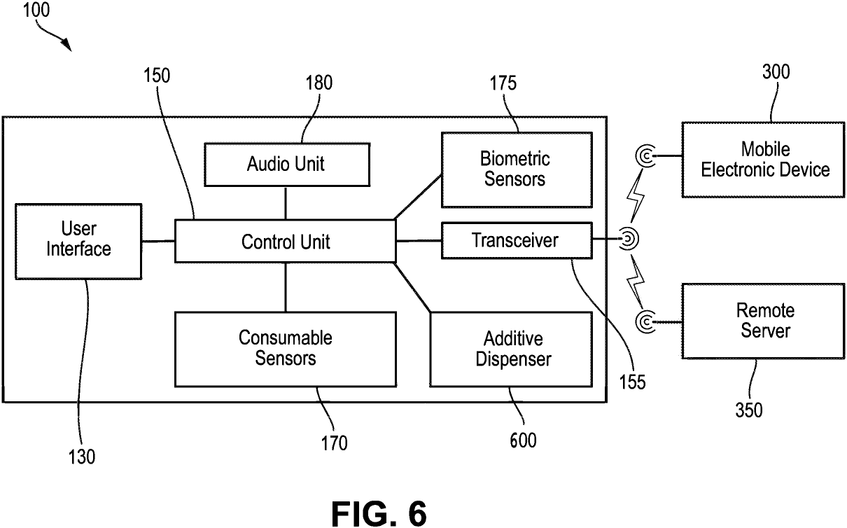

Beverage dispenser 100 may be configured to detect or track the life or remaining amount of each consumable 200. Beverage dispenser 100 may be configured to provide an indication of the remaining life or amount of a consumable. Beverage dispenser 100 may provide an indication or alert to the user when a level of a consumable is low or depleted. For example, beverage dispenser 100 may illuminate an indicator light on user interface 130 to indicate that a particular consumable is low or depleted. In order to indicate that a consumable is low or depleted, beverage dispenser 100 may display a message on display 138, play an audible alert, such as a tone, or may send an alert or message to a mobile electronic device 300 (see, e.g., FIG. 6) of user that is in communication with beverage dispenser 100, such as a push notification, text message, email or the like.

Carbon dioxide tank 210 may store a known quantity of carbon dioxide, and beverage dispenser 100 may store in memory the initial amount, e.g., weight or volume, of carbon dioxide in carbon dioxide tank 210. The initial amount of carbon dioxide may be entered by the user, such as via user interface 130. Alternatively, a sensor 170 of beverage dispenser 100 may read indicia of carbon dioxide tank 210 to automatically determine the amount of carbon dioxide in tank 210. As beverage dispenser 100 is configured to dispense metered doses of carbon dioxide, beverage dispenser 100 may track the amount of carbon dioxide remaining in carbon dioxide tank 210, such as by tracking the weight of the carbon dioxide tank 210 over time. Beverage dispenser 100 may provide an alert when an amount of carbon dioxide remaining in carbon dioxide tank 210 reaches or falls below a predetermined level. For example, beverage dispenser 100 may provide an alert when an amount of carbon dioxide in tank is 20%, 10%, or 5% of the initial amount of carbon dioxide in carbon dioxide tank 210.

Filter cartridge 220 may have a life based on a duration of time or based on a capacity. Beverage dispenser 100 may save a time or date when filter cartridge 220 is installed. The time and date of installation may be input by the user, such as via user interface 130. Alternatively, beverage dispenser 100 may include a sensor 170 for reading indicia, such as a bar code or QR code, of filter cartridge 220 for automatically determining the capacity of the filter cartridge, the usable life, or both. Beverage dispenser 100 may provide an indication to replace filter cartridge 220 after a predetermined period of time, such as for example 6 months from the date of installation. Beverage dispenser 100 may track a quantity of water that is dispensed, and that has been filtered by filter cartridge 220. Beverage dispenser 100 may provide an indication to replace filter cartridge 220 when the quantity of water that has passed through the filter cartridge, i.e., the capacity, has reached a predetermined level, such as for example 5,000 liters. Beverage dispenser 100 may provide an alert to replace filter cartridge 220 when either the filter life or capacity is reached, or is about to be reached. Beverage dispenser 100 may be configured to provide an alert shortly before reaching the filter life or capacity (e.g., when the filter cartridge has reached 80%, 90%, or 95% of its capacity or usable life) in order to provide the user with time to replace filter cartridge 220 before it reaches the end of its usable life.

Additive container 230 may include a known amount of an additive, e.g., 4 oz. Beverage dispenser 100 may store the initial amount of the additive as entered by the user via the user interface 130. Alternatively, sensor 170 may read indicia on additive container 230 to automatically determine an initial amount of additive in additive container 230. As beverage dispenser 100 dispenses metered doses of additive, beverage dispenser 100 may track or estimate the remaining amount of additive at any given time. When the amount of additive falls below a predetermined level, such as 20%, 10%, or 5% of the initial amount of additive, beverage dispenser 100 may provide an alert to the user as discussed above.

Beverage dispenser 100 may provide an alert or indication when a level of a consumable 200 is low, and may further provide a recommendation to order new consumables to replace the depleted consumable. In some embodiments, beverage dispenser 100 may automatically order replacement consumables when beverage dispenser 100 determines that the level of the consumable is low or depleted. In this way, the user need not personally shop for and order the consumables. The automatic ordering of replacement consumables may be a setting that the user can activate or deactivate as desired. The setting may be stored, for example, in a user account or profile.

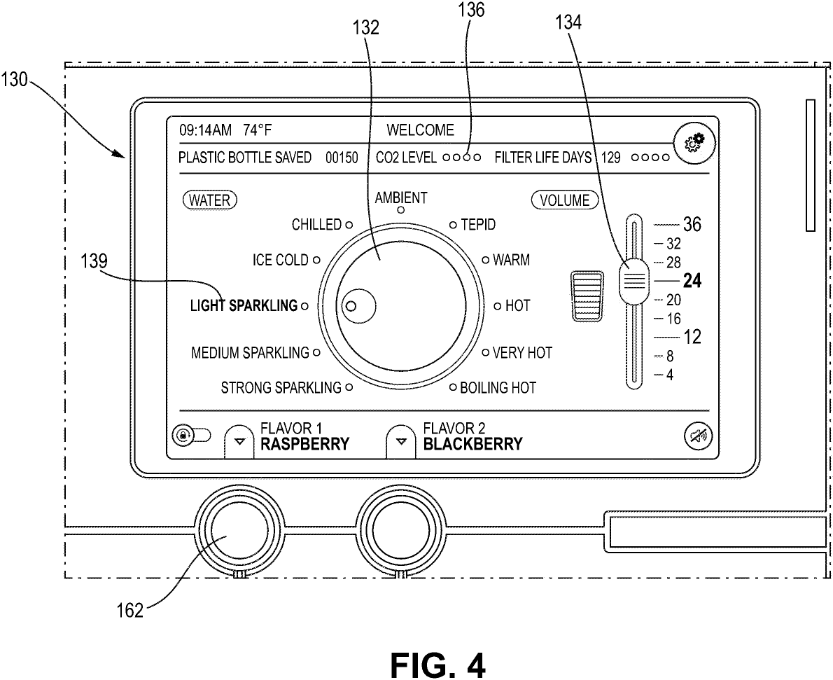

In some embodiments, user interface 130 of beverage dispenser 100 may include input devices that include one or more physical buttons, as shown for example in FIG. 4. Physical buttons may be operated by the user to select a beverage and additive to be dispensed by beverage dispenser 100. For example, as shown in FIG. 4, user interface 130 includes a beverage selector 132 in the form of a dial that can be rotated by the user to select a beverage. The selection may include a base liquid and at least one of a carbonation level and a temperature of the base liquid. For example, different rotational positions of beverage selector 132 may correspond to a base liquid at different carbonation levels, e.g., light sparkling, medium sparkling, or strong sparkling. Different rotational positions may correspond to a temperature of the base liquid, e.g., ice cold, chilled, ambient, tepid, warm, hot, very hot, or boiling hot. It is understood that additional or fewer carbonation and temperature options may be available than shown in FIG. 4. In some embodiments, the user may select to dispense water at any temperature and carbonation level. In some embodiments, still water may be dispensed at any temperature, but when carbonated water is selected (e.g., light, medium, or strong sparkling), the temperature is set by the beverage dispenser 100 to a temperature of 41° F. (5° C.) or less in order to maintain the desired carbonation level.

User interface 130 may include markings 139 to denote the selection at each position of beverage selector 132. For example, markings 139 may include text to describe the selection, i.e., “medium sparkling,” “light sparkling,” “ice cold,” “chilled,” etc. Carbonation selections may be qualitative, such as light, medium or strong carbonation. Similarly, temperature selections may be qualitative, e.g., ice cold, chilled, ambient, tepid, warm, hot, very hot, boiling hot. In some embodiments, selections may be quantitative. Markings 139 may include numbers to represent the temperature in degrees Fahrenheit or Celsius, or to indicate carbonation level by specifying the amount of carbon dioxide to be added. In some embodiments, markings 139 may include graphics or images to represent the selection, such as showing different numbers of bubbles to denote carbonation levels, or a thermometer filled to different levels to represent different temperatures, ice cubes to represent cold selections, fire or flames to indicate hot selections, among others graphics.

User interface 130 may further include a volume selector 134 for selecting a volume of the base liquid to be dispensed. Volume selector 134 may similarly be a dial having rotational positions corresponding to different volumes of the base liquid to be dispensed. However, volume selector 134 may include alternate types of input devices. In FIG. 4, for example, volume selector 134 is shown as a slider. User interface 130 depicts volume selections in a range of 4 oz to 36 oz, in increments of 4 oz. However, in other embodiments, smaller or larger volumes of base liquid may be dispensed, and the increments between the volume selections may be different. In some embodiments, user interface 130 may include text to qualitatively indicate the volume, such as a splash, small, medium, or large pour. In some embodiments, user interface 130 may specify the volume quantitatively, such as 4 oz, 8 oz, 12 oz, etc. In some embodiments, user interface 130 may include graphics or images to show the beverage level in a cup or container to represent the volume to be dispensed.

User interface 130 may display information about the level of consumables in beverage dispenser 100, as described herein. User interface 130 may include indicators 136 corresponding to an amount of carbon dioxide in a carbon dioxide tank, a life of a filter cartridge, and an amount of an additive remaining in an additive container. For example, indicators 136 may include one or more lights (e.g., LEDs) that are illuminated to represent a level or amount of each consumable remaining.

User interface 130 may further include input device to dispense the selected base liquid in the selected volume, e.g., a dispensing button. Alternatively, another portion of beverage dispenser 100, such as base liquid nozzle, may include the dispensing button (see, e.g., button 142 in FIG. 1) that can be operated to dispense the selected base liquid in the selected volume.

In some embodiments, user interface 130 may include no display, so as to provide a simplified user interface 130 and to reduce the cost of manufacturing beverage dispenser 100. In some embodiments, user interface 130 may include a combination of physical buttons and a display. For example, beverage selector 132 may be a dial, and the beverage options at the different rotational positions of the dial may be shown on a display surrounding the dial. In this way, the display can be updated to customize the selections displayed at each rotational position of the dial.

In some embodiments, user interface 130 may include a limited number of input devices to provide a user with a simple and easy-to-use interface for selecting and dispensing a beverage. For example, user interface may include a base liquid selector for selecting a base liquid at a desired temperature and/or carbonation level, a volume selector for selecting the volume of the base liquid to be dispensed, and an additive selector for selecting an additive to be dispensed. The user interface may include a pour or dispense button, or the pour or dispense button may be arranged on a separate portion of beverage dispenser 100, such as on a nozzle 140, 160. In this way, the user can easily select and dispense a beverage without having to navigate a series of separate menus or screens, which the user may find to be cumbersome or inconvenient.

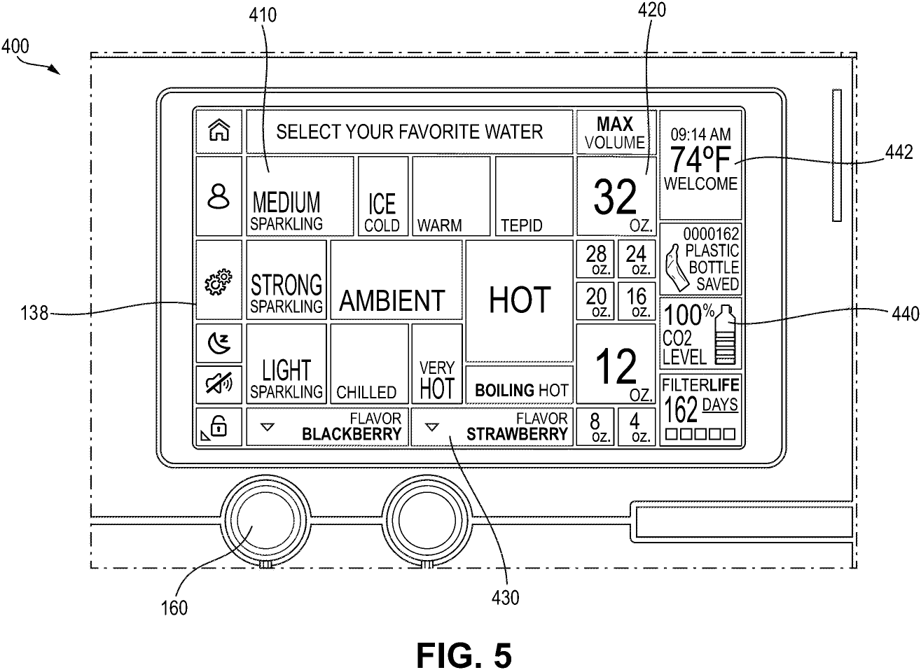

In some embodiments, user interface may include a display 138, such as a touch screen display, as shown in FIG. 5. Display 138 may show a graphical user interface (GUI) 400 for selecting a base liquid. Similar to FIG. 4, GUI 400 may include selections for a base liquid and at least one of a carbonation level and a temperature of the base liquid. As shown in FIG. 5, the selection may be presented as a series of icons or tiles 410 including carbonation level options, e.g., light, medium, or strong carbonation, and temperature level options, such as ice cold, chilled, ambient, tepid, warm, hot, very hot, and boiling hot. As discussed above, the selections may be qualitative, quantitative, may include markings or symbols, or a combination thereof. For example, a tile 410 may include the text “boiling hot” and may include an image of three flames to represent the boiling hot setting.

Volume selections may also include icons or tiles 420 showing different volumes of beverages to be dispensed, such as 4 oz, 8 oz, 12 oz, 16 oz, 20 oz, 24 oz, 28 oz, 32 oz or a maximum volume selection. The volume may be qualitative or quantitative or may include markings, or a combination thereof.

In some embodiments, tiles corresponding to popular or preferred selections may be larger in size than tiles corresponding to less popular or less preferred selections. For example, if beverage dispenser 100 determines that users (or a particular user) commonly select to dispense chilled still water, and rarely select ice cold carbonated water, then the tile for chilled still water may be shown in display in a larger size than a tile for ice cold carbonated water. Further, if the user commonly selects to dispense a volume of 12 oz, and rarely selects to dispense a volume of 4 oz, the icon or tile for a volume of 12 oz may be displayed larger or more prominently than the icon or tile for 4 oz. In some embodiments, the size of the icon or tile may be proportional to the frequency with which the icon or tile is selected. Alternatively, if GUI 400 shows a list of beverage selections, the popular or preferred selections may be presented at the top of the list, whereas less popular selections may be presented lower in the list. The list may be presented in ranked order based on the frequency with which each option is selected.

Additive selections may be shown via additive tiles 430. In some embodiments, each additive tile 430 may be arranged on a portion of display 138 that is closest to the corresponding additive nozzle 160 of beverage dispenser 100 that dispenses the selected additive. For example, a first additive tile may be arranged on display 138 in a location directly above an additive nozzle 160 that dispenses the first additive, and a second additive tile 430 may be arranged on display 138 in a location directly above an additive nozzle that dispenses the second additive.

GUI 400 may further include information about level of consumables in beverage dispenser 100. GUI 400 may include consumable tiles 440 corresponding to a level of carbon dioxide in a carbon dioxide tank, a life of a filter cartridge, and an amount of an additive in an additive container. GUI 400 may display a graphical representation of the carbon dioxide, life of the filter cartridge, or the amount of the additive (e.g., a partially filled container). GUI 400 may display an estimate of the amount of time remaining in the life of the filter, such as the number of days remaining. GUI 400 may display an estimate of the remaining CO₂, and the remaining additive, such as a percentage of the initial CO2 or additive level, respectively.

GUI 400 may display additional information, such as environmental information 442 including the local time, date, and weather (e.g., current temperature, precipitation, forecast, etc.). GUI 400 may further display a greeting. The greeting may be personalized based on the identity of the user. Beverage dispenser 100 may detect the user by biometric recognition, such as by facial recognition, and may display a personalized greeting (e.g., “Welcome Alessandro”) if the user’s identity is known, such as if beverage dispenser recognized the user via biometric recognition or if the user accessed beverage dispenser 100 using a user profile. If the user’s identity is not known, beverage dispenser 100 may display a greeting specific to a new customer, and may prompt the user to create a user profile.

In some embodiments, GUI 400 may be arranged such that beverage selections occupy a first portion of display 138, volume selections occupy a second portion of display 138, additive selections occupy a third portion of display 138, and consumable information and other information may occupy a fourth portion of display 138. The selections may be grouped together for easy access by the user. Further, the selections may be arranged from left to right or from top to bottom in order to guide the user through the series of selections in an intuitive manner.

In some embodiments, user interface 130 and GUI 400 of beverage dispenser 100 may be customized based on the identity of the user. The user may create a user profile that is stored by or is accessible by beverage dispenser 100. The user profile may include user information, such as biometric information, preferred or common beverage and volume selections, a history of dispensed beverages, settings, and preferences, among other information. As discussed, the user’s common selections may be displayed more prominently, such as in a larger size or higher in a list of available selections. In some embodiments, user interface 130 may include adjustable settings for beverage dispenser 100. Settings may include a language, units of measure, currency, light settings (e.g., brightness, color, dimming timer), audio volume, automatic ordering of consumables, or enabling/disabling ads, among others.

In some embodiments, beverage dispenser 100 may allow the user to set or modify the base liquid and volume selections displayed on user interface. For example, the default “hot water” setting may correspond to a temperature of 80° F., and the user may adjust the hot water setting to instead correspond to 90° F. Further, the user may select to add or remove selections from display on user interface 130. For example, the user interface 130 may default to displaying six temperature options, and the user may choose to add or remove one or more of the default temperature options based on the used preferences.

In some embodiments, beverage dispenser 100 may store previously selected or dispensed beverages in memory. After selecting and dispensing a base liquid, the user may subsequently press the dispense button without again selecting a base liquid or a volume in order to dispense the previously dispensed base liquid. Thus, beverage dispenser 100 may default to selection and dispensing of the previously dispensed base liquid. Alternatively, the user may be required to select a base liquid and the previously dispensed base liquid may be displayed prominently in the list of selectable options, such as by including the previously dispensed base liquid as a large tile, or by listing the base liquid at the top of a list of options. This may be helpful for a user in a home setting who frequently dispenses the same base liquid, or for a user in a commercial setting (e.g., a waiter or waitress) who may have to quickly fill multiple cups with the same base liquid. However, in some embodiments, when the previously dispensed base liquid is hot, the hot base liquid may be saved for only a predetermined period of time, such as one minute. This may help to prevent a user from erroneously dispensing a hot liquid, which may result in harm to the user.

In some embodiments, beverage dispenser 100 may be configured to provide advertisements, commercials, or promotional materials, such as visual and audio information, referred to as “ads.” Beverage dispenser 100 may display ads on display 138 of user interface 130. Ads may relate to consumables 200, such as carbon dioxide tanks 210, filter cartridges 220, and additive containers 230, and may relate to removable panels 190, among other products. Beverage dispenser 100 may play ads during a dispensing operation while the user is waiting for a selected beverage to be dispensed. In some embodiments, beverage dispenser 100 may play ads when beverage dispenser 100 is not in use, such as to attract users.

Beverage dispenser 100 may include a setting to enable or disable ads. The setting to enable or disable ads may be a setting in a user profile. If ads are enabled, the user may be offered promotions or discounts, such as discounts on consumables for beverage dispenser 100.

Beverage dispenser 100 may include a control unit 150 configured to control operation of beverage dispenser 100, as shown in FIG. 6. Control unit 150 may be in communication with user interface 130 so as to receive user input at user interface 130. Control unit 150 may control operation of beverage dispenser 100 to prepare and dispense a base liquid having the temperature, carbonation level and volume selected by the user. Thus, control unit 150 may further control operation of pumps, valves, and the like to direct fluid flow within beverage dispenser 100 as will be appreciated by one skilled in the art. Control unit 150 may further control operation of additive dispenser 600 so as to an additive selected by the user.

Beverage dispenser 100 may include a transceiver 155 for communicating with external devices. Transceiver 155 may be configured to send and receive wireless communications. Beverage dispenser 100 may be in communication with a mobile electronic device 300, such as for receiving base liquid, volume and additive selections from a user, or may be in communication with a mobile electronic device of a technician. Mobile electronic device 300 may include a smartphone, a tablet, a laptop, a computer, a smartwatch, among other electronic devices. Mobile electronic device 300 may execute a mobile software application configured to communicate with beverage dispenser 100. Software may include a set of instructions that when executed by mobile electronic device 300 cause a display of the device to show a graphical user interface for receiving a selection of a beverage to be dispensed. Graphical user interface displayed on mobile electronic device 300 may be graphical user interface for selecting a beverage, as discussed above with respect to GUI 400.

Transceiver 155 of beverage dispenser 100 may communicate with a remote external server or computer 350, such as a cloud server, for receiving software updates and patches, among other information. Beverage dispenser 100 may transmit information via transceiver 155, such as system information, usage information, consumables status and replacement needs, operational information, error or safety information, and user information which may be anonymized.

In some embodiments, beverage dispenser 100 may include an audio unit 180, such as a speaker for playing audio, and a microphone for detecting audio information, such as a user’s speech. In some embodiments, beverage dispenser 100 may receive a selection as discussed herein via detecting speech of a user. For example, a user may speak aloud a selection displayed on user interface, such as “dispense medium sparkling water,” and audio unit 180 may detect the user’s speech and dispense the base liquid based on the user’s speech. Further, beverage dispenser 100 may play a message or instructions to the user, such as a greeting, or may provide instructions to guide the user through the beverage selection. Beverage dispenser 100 may play audio to confirm when a selection has been made, and to provide entertainment or otherwise add interest to the dispensing operation.

In some embodiments, one or more sensors 170 may detect information about operation of beverage dispenser 100. In some embodiments, sensors 170 may be configured to detect the presence or absence of consumables, and may detect an amount or level of a consumable in beverage dispenser 100.

In some embodiments, beverage dispenser 100 may include one or more biometric sensors 175. Biometric sensors 175 may be used for performing biometric recognition of the user, such as facial recognition. In such embodiments, biometric sensor 175 may include an optical sensor, such as one or more cameras, configured to detect a face or facial feature, such as the user’s eyes, nose, mouth, eyebrows, ears, distances between facial features, dimensions of facial features, and proportions of facial features. Further, biometric sensor 175 may determine an identity of the user, and user interface 130 may display a user interface based on the user’s identity. In some embodiments, user interface 130 may be off or idle when no user is present as determined by the biometric sensor 175, and may turn on, display a greeting, or display beverage options when a presence of a user is detected.

In some embodiments, beverage dispenser 100 may selectively enable access to certain features or functions depending upon an identity of the user. The features and functions may be default settings, and may be changed by a user of beverage dispenser 100, such as the owner of the dispenser or by a technician. For example, if beverage dispenser 100 determines that the user is a child, the ability to dispense hot beverage may be disabled to prevent scalding injuries to the child. Beverage dispenser 100 may determine that the user is a child, for example, by facial recognition as described herein, or based on a selected user profile of the user as described herein. The child’s settings or permissions may be set by a parent or caregiver, and the parent may choose to disable a child’s access to dispensing additives that may be sugary or to disable the child’s access to carbonated beverages, while allowing access to still water.

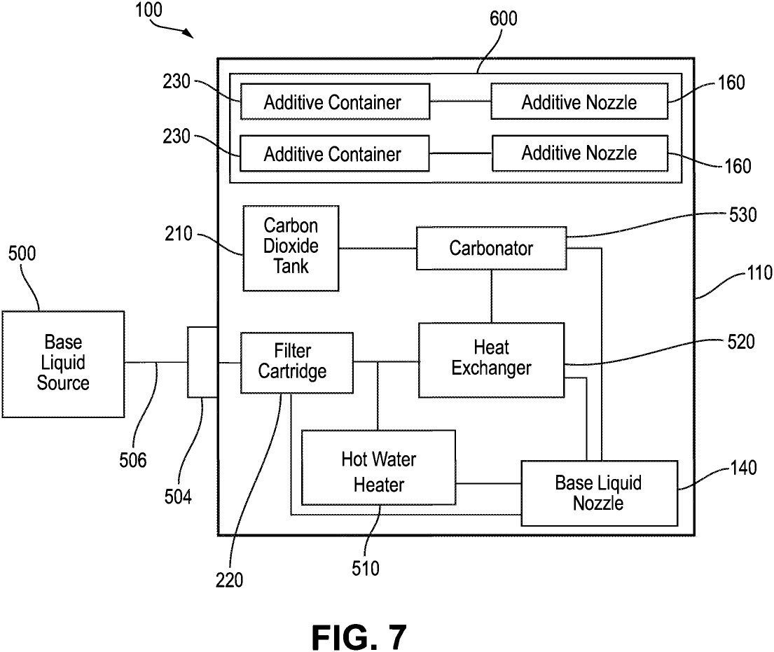

Beverage dispenser 100 may include various components for preparing and dispensing a base liquid and an additive, as shown for example in FIG. 7. In some embodiments, beverage dispenser 100 includes an inlet 504 for connection to a source of a base liquid 500, and base liquid may flow through beverage dispenser 100 and its units via one or more supply lines 506. Inlet 504 may be in communication with a filter cartridge 220 of beverage dispenser 100 for removing contaminants from the base liquid. The base liquid supply line 506 may further be in communication with a hot water heater 510 configured to store and heat the water to be dispensed. Base liquid supply line 506 may also be in communication with a heat exchanger 520 configured to lower a temperature of the base liquid from ambient temperature, i.e., to cool or chill the base liquid. In some embodiments, base liquid supply line 506 may include one or more splitters and valves to direct base liquid to either the hot water heater 510 or to the heat exchanger 520, or to both.

In some embodiments, hot water heater 510 may include tank configured to receive a quantity of the base liquid, and a heating element configured to increase a temperature of the quantity of the base liquid held in the hot water tank. The heating element may include, for example, an electrical resistance heating element. Hot water heater 510 may include a temperature sensor configured to monitor a temperature of the base liquid in the hot water tank. Hot water heater 510 may be configured to heat the water to the selected temperature for the base liquid. In some embodiments, dispensing a beverage at an elevated temperature may include heating the water to the desired temperature in hot water heater 510. Alternatively, hot water heater 510 may be configured to heat the base liquid to a set temperature, and the heated base liquid may be mixed with ambient temperature base liquid to reduce the temperature of the base liquid to the selected temperature.

In some embodiments, heat exchanger 520 may include a container filled with a heat exchange fluid, such as water, and a chiller coil may be arranged within the container and submerged in the heat exchange fluid. The base liquid flows through the chiller coil in order to remove heat from the base liquid and to cool the base liquid to a desired temperature. In some embodiments, beverage dispenser 100 may mix chilled base liquid with ambient temperature base liquid to provide the base liquid at the selected temperature. Mixing of chilled and ambient base liquid to prepare the base liquid at the desired temperature may occur at the dispensing nozzle. In other embodiments, base liquid may be chilled to a desired temperature by adjusting operation of the heat exchanger 520, such as by changing a speed at which base liquid flows through the heat exchanger 520 or by increasing the residence time of the base liquid in the heat exchanger 520.

Beverage dispenser 100 may include a carbonator 530 configured to carbonate the base liquid. Carbonator 530 may be in communication with carbon dioxide tank 210 for receiving carbon dioxide from carbon dioxide tank 210. Carbonator 530 may be in communication with heat exchanger 520 such that cooled or chilled base liquid is provided to carbonator 530. However, in some embodiments, carbonator 530 may be arranged within or formed as part of heat exchanger 520. For example, carbonator 530 may be an in-line carbonator and may be arranged within a tank of heat exchange fluid of heat exchanger 520. Carbonator 530 may be in communication with base liquid nozzle 140 for dispensing the beverage.

Beverage dispenser 100 may include an additive dispenser 600 including one or more additive containers 230 each in communication with a respective additive nozzle 160. Additives may have a high concentration such that a small amount of additive may be combined with a base liquid to provide a flavored beverage with a desired flavor and taste. For example, an additive may have a dilution ratio of base liquid to additive of 100:1, 200:1, 300:1, or 400:1. While using a highly concentrated additive helps to conserve space, consumers may find it difficult to properly dose a highly concentrated additive. In order to help the user dispense an appropriate dose, a beverage dispenser may dispense a fixed dose of additive, but some consumers may wish to customize the level of flavor in a beverage. Thus, it is desired to provide an additive dispenser that uses a highly concentrated additive while allowing the user to customize their beverage.

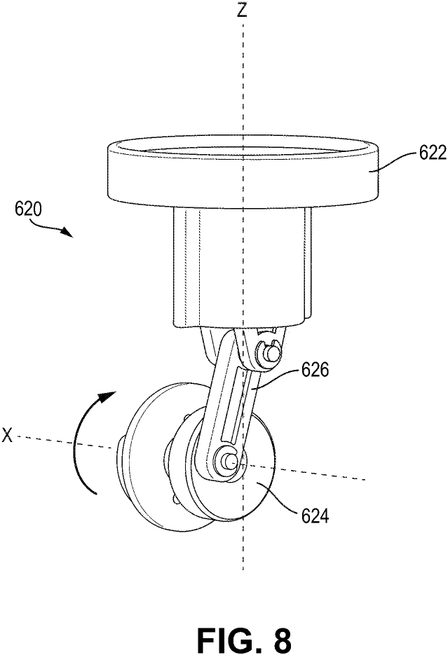

In some embodiments, additive dispenser 600, as shown for example in FIG. 3, may include a dispensing mechanism 620 for dispensing additive from additive container 230 by additive nozzle 160. In some embodiments, dispensing mechanism 620 may include a movable holder 622 (see, e.g., FIG. 8) configured to support additive container 230. Dispensing mechanism 620 may include a connection 628 for placing additive container 230 in communication with additive nozzle. Connection 628 may engage an open upper end of additive container, such as by a threaded connection. Dispensing mechanism 620 may include a pump 630 secured to an opening of additive container 230, such as the open upper end of additive container 230. Pump 630 is in fluid communication with additive nozzle 160. Dispensing mechanism 620 may include a drive mechanism, such as a motor, for moving holder 622 along a longitudinal axis so as to reciprocally move additive container 230 up and down, thereby actuating pump 630 such that additive is provided to additive nozzle 160 for dispensing. Each stroke (up and down movement) of dispensing mechanism 620 corresponds to dispensing a fixed amount of additive from additive container 230, such that additive may be dispensed in a precise amount based on the number of strokes of dispensing mechanism 620.

In some embodiments, as shown in FIG. 8, dispensing mechanism 620 may include a rotatable disk 624 that rotates about a horizontal axis X and that is driven by a drive mechanism, such as a motor. A linkage 626 has a first end that is movably connected to a portion of disk 624 away from a center of disk 624 and a second end movably connected to holder 622. Linkage 626 transforms rotational movement of disk 624 into linear movement of holder 622 and additive container 230 thereon along a longitudinal axis Z that is perpendicular to the horizontal axis. The circular motion of disk 624 may provide a smooth operation of dispensing mechanism 620. However, in some embodiments, holder 622 may be driven by a linear actuator, such as a solenoid.

When an additive is selected for dispensing, such as via user interface, beverage dispenser 100 may automatically determine the dose of the additive to be dispensed based on the selected volume of the base liquid and a dilution ratio for the selected additive. For example, if the consumer selects to dispense 12 oz of cold, still water, and selects an additive with a dilution ratio of 100:1, additive dispenser 600 may dispense 0.12 oz of additive. Further, if it is known that each stroke of dispensing mechanism 620 dispenses 0.02 oz of additive, beverage dispenser 100 will cause additive dispenser 600 to complete 6 strokes in order to dispense 0.12 oz of additive.

The user may dispense the additive by operating a dispense button 162. Beverage dispenser 100 may include a dispense button 162 on or adjacent to additive nozzle 160, or on user interface 130. In the event the user wishes to dispense additional flavoring, the user may press dispense button 162 a second or subsequent time. After the initial additive dose is dispensed, each subsequent press of dispense button 162 may correspond to dispensing a fixed amount of additive. Continuing with the above example, the first press of dispense button 162 may dispense a volume of additive determined based on the volume of the base liquid selected and the dilution ratio of the additive, and each subsequent press may dispense 0.04 oz of additive to allow the user to customize the level of flavor in the beverage.

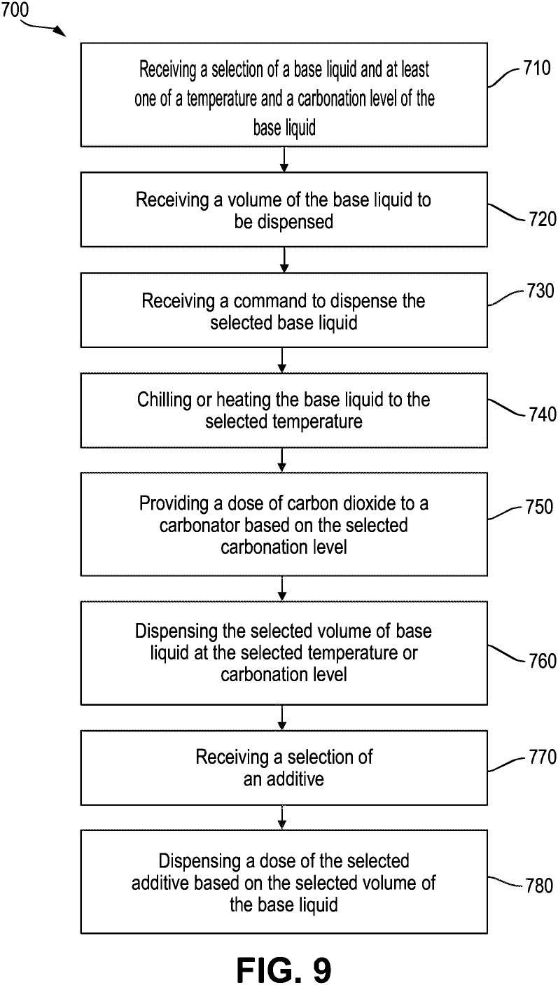

An exemplary method of operating beverage dispenser 700 is shown in FIG. 9. Beverage dispenser may receive a selection of a base liquid 710. Selecting a base liquid may include selecting a base liquid at a desired temperature or carbonation level. Beverage dispenser may receive a volume of base liquid to be dispensed 720. Beverage dispenser may receive a command to dispense the selected base liquid 730. Beverage dispenser may chill or heat the base liquid to the selected temperature 740. For example, beverage dispenser may cause a base liquid to flow to a heat exchanger or a hot water heater in order to cool or heat the base liquid to the selected temperature. Alternatively, beverage dispenser may provide a dose of carbon dioxide to a carbonator based on the selected carbonation level 750. Beverage dispenser may then dispense the selected volume of base liquid at the selected temperature or carbonation level 760. In some embodiments, beverage dispenser may further receive a selection of an additive 770. Beverage dispenser may dispense a dose of the selected additive based on the selected volume of the base liquid 780. For example, beverage dispenser may know the dilution ratio for the selected additive, and may dispense a volume of the additive based on the volume of the selected base liquid to achieve the known dilution ratio. It is understood that the base liquid and additive may be dispensed in any order. For example, a user may select and dispense an additive and may then dispense the base liquid, or vice versa. Further, user may not dispense an additive at all.

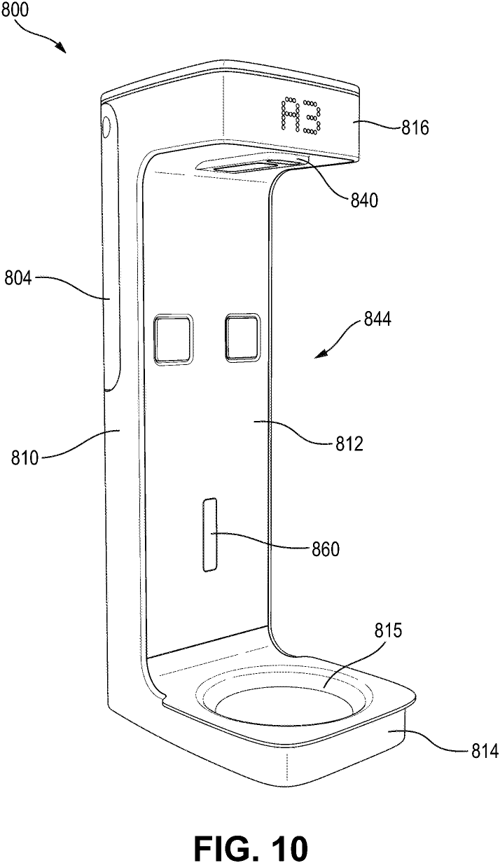

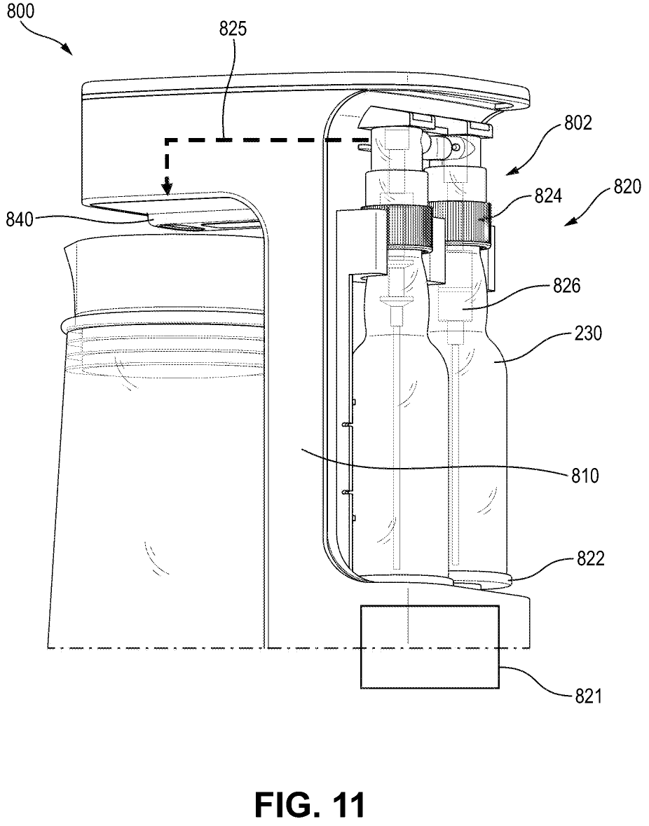

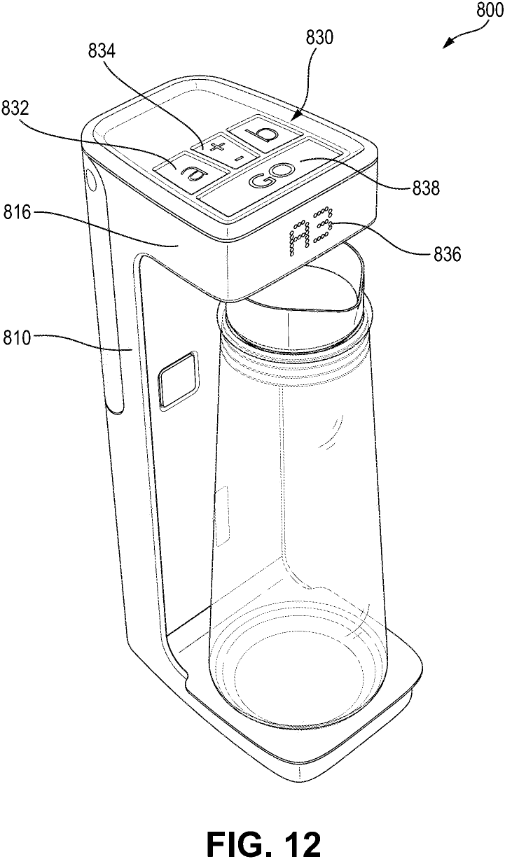

Some embodiments described herein relate to an additive dispenser 800 configured as a stand-alone device. While an additive dispenser 600 has been described in connection with beverage dispenser 100, some embodiments described herein relate to an additive dispenser 800 that is a stand-alone device, as shown for example in FIGS. 10-13. Additive dispenser 800 may be configured to dispense metered quantities of additives as selected by a user. In embodiments in which additive dispenser 800 is a stand-alone device, additive dispenser 800 may include a housing 810 having a dispensing mechanism 820 (see, e.g., FIG. 11) for dispensing additive from an additive container, and a user interface 830 (see, e.g., FIG. 12) for receiving selection of an additive and an amount of additive to be dispensed.

Housing 810 may enclose components of additive dispenser 800. In some embodiments, housing 810 includes a main body 812, a base 814 at a lower end of main body 812, and a head 816 at an upper end of main body 812. Housing 810 may define a storage compartment 802 for receiving additive containers 230. Housing 810 may include a panel 804 removably securable to housing 810 to enclose storage compartment 802 and additive containers 230 within housing 810.

One or more additive nozzles 840 may be arranged on head 816 of additive dispenser 800, such as on a lower surface of head 816. Head 816 may overhang main body 812 of housing 810 so as to form a beverage container receiving area 844 between head 816 and base 814. In some embodiments, a single additive nozzle 840 may be used to dispense one or more additives, and may be in communication with one or more sources of additives. This may help to reduce the number of components and to simplify the design of additive dispenser 800. Alternatively, additive dispenser 800 may include a plurality of additive nozzles 840, wherein each additive nozzle 840 corresponds to a particular additive container. This may help to prevent or minimize cross-over of flavors.

Base 814 of housing 810 may be configured to rest on a support surface, such as a countertop. Base 814 may receive a beverage container thereon to be receive an additive. Base 814 may include a recess 815 to facilitate receiving and positioning a beverage container on additive dispenser 800 in a position below an additive nozzle 840.

Additive dispenser 800 may include one or more sensors 860 configured to detect a presence of a beverage container in beverage container receiving area 844. In some embodiments, sensor 860 may be arranged on head 816 of additive dispenser 800, sensor 860 may be arranged on main body 812 of additive dispenser 800, or both. If a beverage container is not detected by the one or more sensors 860, additive dispenser 800 may prevent dispensing of additive to avoid spills and waste of additive.

Additive dispenser 800 may include a dispensing mechanism 820 as shown in FIG. 11. Dispensing mechanism 820 may have the same components and operation as described above with respect to dispensing mechanism 620. Thus, dispensing mechanism 820 may include a movable holder 822 for supporting an additive container 230. Holder 822 may be movable via a drive mechanism 821, which may include a motor, that is operably connected to holder 822. An upper end of additive container 230 may be removably secured to a connection 824 of additive dispenser 800 to place additive container 230 in fluid communication with additive nozzle 840, such as via a conduit 825 (represented by dotted lines). Additive dispenser 800 may include a pump 826 such that when movable holder 822 moves additive container 230, pump 826 is actuated to dispense a predetermined quantity of additive from additive container 230.

User interface 830 of additive dispenser 800 may include one or more input devices, such as buttons, levers, knobs, dials, switches or the like, as shown for example in FIG. 12. User interface 830 may include an additive selection input device(s) 832. Additive selection input devices 832 may allow for receipt of selection of an additive, such as additive A or additive B. User interface 830 may include a volume selection input device 834. The volume of additive to be dispensed may be selected by a number of drops of additive, such as 1 drop to 6 drops. Additive dispenser 800 may limit the number of drops to be dispensed, e.g., 6 drops being the greatest number of drops that is selectable, in order to prevent the user from dispensing too large of a dose of additive that may create an unpalatable beverage. In this way, additive dispenser 800 assists the user in precisely dispensing small volumes of additive while allowing the user to customize the flavor of the beverage within a predefined range.

Additive dispenser 800 may include a display 836 that shows the selected additive and the selected volume. This may help the user to confirm that the desired additive and volume is being dispensed. For example, as shown in FIG. 12, additive dispenser 800 includes a display 836 on head 816 that shows “A3” to indicate that 3 drops of additive A is selected. After the user has selected the additive, and the amount of additive, the user may operate a dispense input device 838 of user interface 830 to dispense the selected amount of the selected additive via additive nozzle 840.

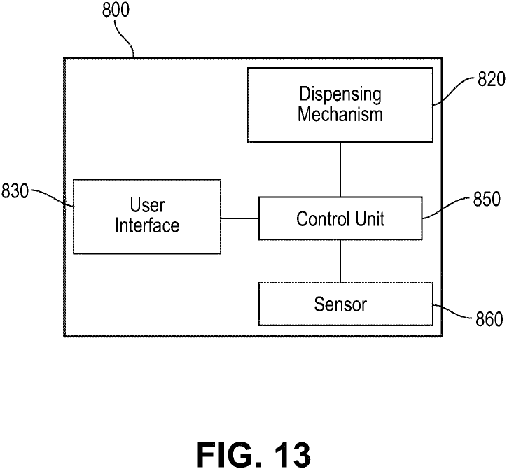

Additive dispenser 800 may include a control unit 850 in communication with dispensing mechanism 820, user interface 830, and sensors 860, as shown for example in FIG. 13. Control unit 850 may receive user input from user interface 830 and may operate dispensing mechanism 820 based on the user input to dispense the selected amount of the selected additive. Control unit 850 may receive information from sensors 860 to determine if a beverage container is present, and to prevent dispensing of additive if no beverage container is detected in beverage container receiving area 844.

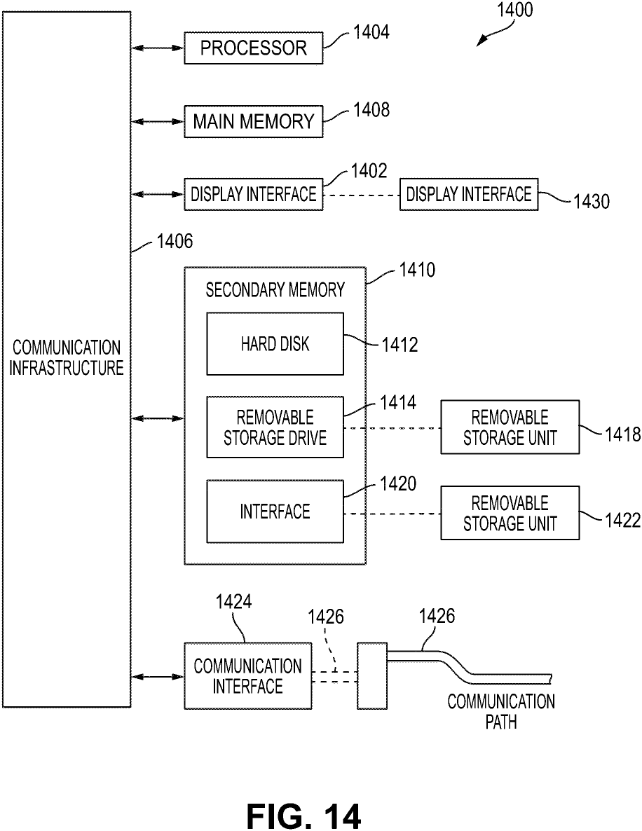

FIG. 14 illustrates an exemplary computer system 1400 in which embodiments, or portions thereof, may be implemented as computer-readable code. A control unit 150, 850 as discussed herein may be a computer system having all or some of the components of computer system 1400 for implementing processes discussed herein.

If programmable logic is used, such logic may execute on a commercially available processing platform or a special purpose device. One of ordinary skill in the art may appreciate that embodiments of the disclosed subject matter can be practiced with various computer system configurations, including multi-core multiprocessor systems, minicomputers, and mainframe computers, computer linked or clustered with distributed functions, as well as pervasive or miniature computers that may be embedded into virtually any device.

For instance, at least one processor device and a memory may be used to implement the above described embodiments. A processor device may be a single processor, a plurality of processors, or combinations thereof. Processor devices may have one or more processor “cores.”

Various embodiments may be implemented in terms of this example computer system 1400. After reading this description, it will become apparent to a person skilled in the relevant art how to implement one or more of the invention(s) using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 1404 may be a special purpose or a general purpose processor device. As will be appreciated by persons skilled in the relevant art, processor device 1404 may also be a single processor in a multi-core/multiprocessor system, such system operating alone, or in a cluster of computing devices operating in a cluster or server farm. Processor device 1404 is connected to a communication infrastructure 1406, for example, a bus, message queue, network, or multi-core message-passing scheme.

Computer system 1400 also includes a main memory 1408, for example, random access memory (RAM), and may also include a secondary memory 1410. Secondary memory 1410 may include, for example, a hard disk drive 1412, or removable storage drive 1414. Removable storage drive 1414 may include a floppy disk drive, a magnetic tape drive, an optical disk drive, a flash memory, or the like. The removable storage drive 1414 reads from and/or writes to a removable storage unit 1418 in a well-known manner. Removable storage unit 1418 may include a floppy disk, magnetic tape, optical disk, a universal serial bus (USB) drive, etc. which is read by and written to by removable storage drive 1414. As will be appreciated by persons skilled in the relevant art, removable storage unit 1418 includes a computer usable storage medium having stored therein computer software and/or data.

Computer system 1400 (optionally) includes a display interface 1402 (which can include input and output devices such as keyboards, mice, etc.) that forwards graphics, text, and other data from communication infrastructure 1406 (or from a frame buffer not shown) for display on display 1440.

In alternative implementations, secondary memory 1410 may include other similar means for allowing computer programs or other instructions to be loaded into computer system 1400. Such means may include, for example, a removable storage unit 1422 and an interface 1420. Examples of such means may include a program cartridge and cartridge interface (such as that found in video game devices), a removable memory chip (such as an EPROM, or PROM) and associated socket, and other removable storage units 1422 and interfaces 1420 which allow software and data to be transferred from the removable storage unit 1422 to computer system 1400.

Computer system 1400 may also include a communication interface 1424. Communication interface 1424 allows software and data to be transferred between computer system 1400 and external devices. Communication interface 1424 may include a modem, a network interface (such as an Ethernet card), a communication port, a PCMCIA slot and card, or the like. Software and data transferred via communication interface 1424 may be in the form of signals, which may be electronic, electromagnetic, optical, or other signals capable of being received by communication interface 1424. These signals may be provided to communication interface 1424 via a communication path 1426. Communication path 1426 carries signals and may be implemented using wire or cable, fiber optics, a phone line, a cellular phone link, an RF link or other communication channels.

In this document, the terms “computer program medium” and “computer usable medium” are used to generally refer to media such as removable storage unit 1418, removable storage unit 1422, and a hard disk installed in hard disk drive 1412. Computer program medium and computer usable medium may also refer to memories, such as main memory 1408 and secondary memory 1410, which may be memory semiconductors (e.g. DRAMs, etc.).

Computer programs (also called computer control logic) are stored in main memory 1408 and/or secondary memory 1410. Computer programs may also be received via communication interface 1424. Such computer programs, when executed, enable computer system 1400 to implement the embodiments as discussed herein. In particular, the computer programs, when executed, enable processor device 1404 to implement the processes of the embodiments discussed here. Accordingly, such computer programs represent controllers of the computer system 1400. Where the embodiments are implemented using software, the software may be stored in a computer program product and loaded into computer system 1400 using removable storage drive 1414, interface 1420, and hard disk drive 1412, or communication interface 1424.

Embodiments of the invention(s) also may be directed to computer program products comprising software stored on any computer useable medium. Such software, when executed in one or more data processing device, causes a data processing device(s) to operate as described herein. Embodiments of the invention(s) may employ any computer useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.).

It is to be appreciated that the Detailed Description section, and not the Summary and Abstract sections, is intended to be used to interpret the claims. The Summary and Abstract sections may set forth one or more but not all exemplary embodiments of the present invention(s) as contemplated by the inventors, and thus, are not intended to limit the present invention(s) and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention(s) that others can, by applying knowledge within the skill of the art, readily modify and/or adapt for various applications such specific embodiments, without undue experimentation, and without departing from the general concept of the present invention(s). Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance herein.

What is claimed is:

1. A beverage dispenser, comprising:
a housing;
a base liquid nozzle arranged on the housing and configured to dispense a base liquid;
an additive nozzle arranged on the housing and configured to dispense an additive;
a user interface arranged on the housing, wherein the user interface is configured to receive a first selection of a base liquid and at least one of a temperature of the base liquid and a carbonation level of the base liquid, and a second selection of an additive;
wherein the beverage dispenser is configured to dispense the base liquid from the base liquid nozzle based on the first selection, and wherein the additive nozzle is configured to dispense the additive based on the second selection.

2. The beverage dispenser of claim 1, wherein the beverage dispenser is further configured to receive a selection of a volume of the base liquid to be dispensed.

3. The beverage dispenser of claim 1, wherein the user interface comprises a touch screen display configured to display a plurality of selectable options.

4. The beverage dispenser of claim 3, further comprising a biometric sensor configured to determine an identity of the user, and wherein the plurality of selectable options is based on the identity of the user.

5. The beverage dispenser of claim 1, wherein the beverage dispenser comprises a carbonator configured to carbonate the base liquid, and wherein the beverage dispenser provides a dose of carbon dioxide to the carbonator based on the selected carbonation level.

6. The beverage dispenser of claim 1, wherein the beverage dispenser comprises a heat exchanger configured to cool the base liquid.

7. The beverage dispenser of claim 1, wherein the beverage dispenser comprises a hot water heater configured to heat the base liquid.

8. The beverage dispenser of claim 1, wherein the housing defines a storage compartment for removably receiving a consumable for operating the beverage dispenser, wherein the consumable is selected from a carbon dioxide tank, a filter cartridge, and an additive container.

9. The beverage dispenser of claim 8, further comprising an indicator configured to indicate an amount of the consumable remaining in the beverage dispenser.

10. The beverage dispenser of claim 1, wherein the housing comprises one or more removable panels.

11. A beverage dispenser, comprising:
a housing;
a base liquid nozzle configured to dispense a base liquid;
a user interface configured to receive a selection comprising a base liquid and at least one of a temperature of the base liquid and a carbonation level of the base liquid; and
an additive dispenser, comprising:
an additive nozzle arranged on the housing;
a holder configured to removably receive an additive container;
a dispensing mechanism configured to dispense a dose of additive from the additive container via the additive nozzle.

12. The beverage dispenser of claim 11, wherein the user interface is configured to receive a selection of a volume of the base liquid to be dispensed.

13. The beverage dispenser of claim 12, wherein the dose of the additive dispensed by the dispensing mechanism is based on the selected volume of the base liquid.

14. The beverage dispenser of claim 11, the user interface is configured to display selectable options based on an identity of the user.

15. A method of dispensing a beverage from a beverage dispenser, the method comprising:
receiving, by the beverage dispenser, a selection of a base liquid and at least one of a temperature of the base liquid and a carbonation level of the base liquid;
receiving, by the beverage dispenser, a volume of the base liquid to be dispensed;
receiving, by the beverage dispenser, a command to dispense the selected base liquid;
chilling or heating the base liquid by the beverage dispenser to the selected temperature or providing a dose of carbon dioxide into a carbonator of the beverage dispenser, wherein the dose is based on the selected carbonation level; and
dispensing the selected volume of the base liquid at the selected temperature or carbonation level.

16. The method of claim 15, further comprising receiving, by the beverage dispenser, a selection of an additive.

17. The method of claim 16, further comprising dispensing a dose of the selected additive based on the selected volume of the base liquid.

18. The method of claim 15, wherein receiving a selection of a base liquid comprises receiving the selection from a mobile electronic device.

19. The method of claim 15, further comprising displaying selectable options for the base liquid on a user interface of the beverage dispenser.

20. The method of claim 19, further comprising detecting an identity of a user, wherein the selectable options displayed on the user interface is based on the identity of the user.
